(19) United States
(12) Patent Application Publication
(10) Pub. No.: US 2004/0050210 A1
(43) Pub. Date: Mar. 18, 2004

(54) Method for reprocessing dust or dust mixtures

(76) Inventor: Alfred Edlinger, Bartholomaberg (AT)

Correspondence Address: Robert J Schneider, Chapman & Cutler, 111 West Monroe Street, Chicago, IL, 60603, US

(21) Appl. No.: 10/181,915

(22) PCT Filed: Jan. 18, 2001
(86) PCT No.: PCT/AT01/00011

(30) Foreign Application Priority Data
Jan. 28, 2000 (AT) GM 64/2000

(51) Int. Cl. C21C 5/34

(52) U.S. Cl. 75/533

(57) ABSTRACT

In a method for processing dusts or dust mixtures containing alkalis and heavy metals, such as, e.g., steelworks dusts, fine ores or blast furnace dusts, the dusts are charged onto or into, in particular top-blown on or blown into, a bath of molten metals and liquid oxidic slags. Volatile heavy metal compounds such as, e.g., Zn and/or Pb oxides are separated from the gaseous phase and alkalis are introduced into the slags.

The invention relates to a method for processing dusts or dust mixtures containing alkalis and heavy metals, such as,. e.g., steelworks dusts, fine ores or blast furnace dusts, dusts from sintering plants, rolling mills, waste incineration plants as well as residual substances and ashes from combustion plants and shredder works.

In the course of blast furnace and steelworks processes, high amounts of dusts occur, as a rule, the processing of which involves a number of problems. Depending on the origin of such dusts, the latter, as a rule, contain considerable amounts of heavy metals whose concentrations usually are, however, too low to be directly processed economically. In particular, steelworks filter dust may contain more than 10 wt.-% zinc oxide and lead oxide.

In the course of the processing of oxidic slags, a number of methods have already been proposed, by which not only the basicities of the slags are adjusted with a view to enabling their use as grinding additives in the cement industry, but, at the same time, also the purification and depletion of undesired components are effected, part of which, in the metallic form, may be converted into a metal bath, partially reoccuring as secondary dusts or being recoverable from the gaseous phase. In methods of this type in which oxidic slags are to be optimized in terms of composition with a view to enabling their subsequent use in cement technology, a number of additives and/or correctives are introduced or blown in, whereby it is also feasible by such methods to safely dispose of noxious substances and, in particular, organically loaded substances.

The invention aims to ensure the economically efficient processing of dusts or dust mixtures of the initially defined kind and, at the same time, provide the opportunity to treat slags in a manner as to facilitate their further utilization in cement technology. To solve this object, the method according to the invention essentially consists in that the dusts are charged onto or into, in particular top-blown on or blown into, a bath of molten metals and liquid oxidic slags and that volatile heavy metal compounds such as, e.g., Zn or Pb oxides are separated from the gaseous phase and alkalis are introduced into the slags. By charging such dusts or filter dusts onto or into a bath of molten metals and, above all, of molten pig iron and liquid oxidic slags, it is feasible to effect a phase separation at an extremely high selectivity, whereby, in particular, the alkalis contained in the original dusts to the major portion will remain within the slag and heavy metals such as zinc and lead will again be found in the secondary dust in a substantially more concentrated form, the overall dust amount introduced, at the same time, being reducible substantially and, in particular, to far below half of the original amount. In addition to the essential effect of reducing the amount of dust, it is, thus, feasible within the context of the method according to the invention to form secondary dusts whose economic further use is substantially facilitated on account of the higher concentrations of the individual components whose recovery appears suitable, the simultaneous enrichment of the oxidic slags with alkalis imparting on the product enhanced properties in regard to a possible cement-technological further use.

In the context of the method according to the invention, it is advantageously proceeded in a manner that the basicities of the liquid slags are adjusted to values of, for instance, between 1 and 1.4 prior dust charging. Liquid oxidic slags exhibiting such basicities and floating on a pig iron bath stand out for their particularly high selectivity in the desired separation of alkalis at a simultaneously low tendency to taking up heavy metals. At the same time, it is feasible within the context of such a method, to reduce the iron oxide content of the dusts or filter dusts used, so that the recovery of molten iron from such dusts is feasible as a side effect, thus further enhancing the economy of the method. In addition to the substantial reduction of the overall dust amount, it is, thus, feasible to recover iron from iron oxides and, at the same time, enrich heavy metals in the secondary dust, thus providing particularly beneficial conditions for the economically efficient recovery of the individual components contained in the secondary dusts.

In a particularly advantageous manner, the introduction of the dusts is effected by means of pneumatic conveyance, it being advantageously proceeded such that the dusts are pneumatically conveyed onto or to below the metal or slag surface and blown in or top-blown by the aid of conveying gases, in particular hot blast.

Such a pneumatic conveyance allows for the realization of a homogenous blending with additives simultaneously with the introduction of the dusts, which additives will subsequently facilitate the pneumatic conveyance, on the one hand, and, at the same time, enable the simultaneous introduction of desired components into the oxidic slags, on the other hand. In a particularly advantageous manner it may be proceeded, in particuar, such that the dusts to be processed are mixed with additives such as, e.g., coal, sand and/or bauxite, whereby, for instance with the use of coal, in addition to ensuring an improved pneumatic conveyability, also the appropriate reduction potential for the continuous separation of metallic iron from iron oxides contained in the dusts is provided, at the same time. The addition of sand and bauxite likewise allows for an enhancement of the pneumatic conveyability, whereby such additives, at the same time, may serve to correct the desired target basicities of the oxidic slags and to adjust an optionally desired higher aluminum content of the slag.

Within the context of the method according to the invention, it is, however, also feasible, at the same time, to safely treat a number of other problem substances such as, in particular, organically loaded substances and, in particular, slurries and sludges, such additives likewise being suitable to enhance the pneumatic conveyance of the dusts by preventing the formation of agglomerates. When charging such dusts mixed with organically loaded substances, it is feasible to completely burn the organic portions, whereby additional reduction potential can be made available for the reduction of iron oxides from the dusts, at the same time.

Advantageously, a pig iron bath is provided as the metal bath within the context of the method according to the invention, the bath in a particularly advantageous manner containing liquid slags and molten pig iron at weight ratios of 1:3 to 1:6, preferably 1:4.

In a particularly simple manner, the introduction of the dusts or dust mixtures is effected in that the latter are blown into the converter through bottom tuyeres. After the reaction, which takes place, in particular, on the interphase between slag and metal bath, secondary dust occurs in an amount which is much lower than a third of the original amount, even lies below 10% of the original amount.

In the following, the invention will be explained in more detail by way of an exemplary embodiment. In a converter, 2 tons of a slag having the composition indicated below were produced on a bath comprised of 10 tons of molten pig iron:

Slag

| | mass-% |
|---|---|
| CaO | 47.9 |
| SiO₂ | 36.6 |
| Al₂O₃ | 7.3 |
| MgO | 2.9 |
| TiO₂ | 1.2 |
| FeO | 1.6 |
| MnO | 2.1 |
| Na₂O | 0.1 |
| K₂O | 0.2 |
| ZnO | 0 |
| PbO | 0 |

This slag is characterized by a basicity that is beneficial to its subsequent utilization in cement technology and, as a rule, contains only low portions of alkalis. For certain cement properties and, in particular, the strength properties such as, for instance, the early strength, of mortar or concrete mixtures produced with such slags as grinding additives, a higher alkali content would be desirable, anyway.

1 ton of steelworks filter dust having the composition indicated below was blown into such a bath through bottom tuyeres:

Filter dust

| | wt.-% |
|---|---|
| CaO | 7.1 |
| SiO₂ | 5.0 |
| Al₂O₃ | 1.3 |
| MgO | 2.9 |
| TiO₂ | 0.4 |
| FeO | 64.0 |
| MnO | 4.2 |
| Na₂O | 2.8 |
| K₂O | 0.1 |
| ZnO | 11.5 |
| PbO | 0.7 |

The steelworks filter dust, thus, contained considerable amounts of alkalis and heavy metals. By the penetration of the bath, a phase separation occurred, whereby the alkalis contained in the original dust were bound in the slag at a high selectivity and the heavy metals zinc and lead could be found again in the secondary dust as the respective oxides in concentrated forms. After the treatment of the steelworks filter dusts, a slag composition having the following directional analysis had adjusted:

Final slag composition

| | wt.-% |
|---|---|
| CaO | 46.9 |
| SiO₂ | 35.4 |
| Al₂O₃ | 7.3 |
| MgO | 3.9 |
| TiO₂ | 1.2 |
| FeO | 1.7 |
| MnO | 2.0 |
| Na₂O | 1.2 |
| K₂O | 0.4 |
| ZnO | 5 ppm |
| PbO | <5 ppm |

Secondary dust having the composition below was obtained in an amount of approximately 264 kg:

Secondary filter dust composition

| | wt.-% |
|---|---|
| CaO | 4.2 |
| SiO₂ | 3.1 |
| Al₂O₃ | 1.2 |
| MgO | 0.1 |
| TiO₂ | 0.2 |
| FeO | 47.8 |
| MnO | 0.4 |
| Na₂O | 0.2 |
| K₂O | 0.4 |
| ZnO | 39.8 |
| PbO | 2.6 |

A comparison of the composition of the used steelworks filter dust with the composition of the secondary filter dust, and a comparison of the slag compositions, reveal that K₂O was to be found again in the secondary filter dust by about 3.2%, whereas 96.8 wt.-% of the K₂O content of the dust used were to be found in the product slag. Similar applies to the distribution of the original Na₂O content, 4.5 wt.-% of the original portion having been found in the secondary filter dust and 95.5 wt.-% having been found in the product slag.

Things are different with the zinc oxide and lead oxide values which were found to be 99.7 and 99.9 wt.%, respectively, in the secondary filter dust. Due to the overall reduction of the amount of secondary filter dust, based on the amount of steelworks dust used, the secondary filter dust then contained portions of these heavy metals, which let economic processing appear suitable. Only about 0.3 and 0.1 wt.-%, respectively, of the zinc oxide and lead oxide portions contained in the steelworks dust used could be determined in the product slag.

1. A method for processing dusts or dust mixtures containing alkalis and metals, comprising the steps of
providing a bath of molten metals and liquid oxidic slags, wherein the basicities of said liquid slags are adjusted to values of between 1 and 1.4, and
pneumatically conveying dusts onto or into said bath, wherein said dusts are delivered onto or below a top surface of said slags by the aid of conveying gases, whereby volatile heavy metal compounds are separated from the gaseous phase and alkalis are introduced into said slags.

2. A method according to claim 1, wherein hot blast is used as said conveying gases.

3. A method according to claim 1, wherein the dusts are mixed with additives.

4. A method according to claim 2, wherein the dusts are mixed with additives.

5. A method according to claim 3, wherein said additives are at least one of the group consisting of coal, sand and bauxite.

6. A method according to claim 4, wherein said additives are at least one of the group consisting of coal, sand and bauxite.

7. A method according to claim 1, wherein the dusts are mixed with organically loaded substances.

8. A method according to claim 2, wherein the dusts are mixed with organically loaded substances.

9. A method according to claim 3, wherein the dusts are mixed with organically loaded substances.

10. A method according to claim 1, wherein said bath is a pig iron bath.

11. A method according to claim 2, wherein said bath is a pig iron bath.

12. A method according to claim 3, wherein said bath is a pig iron bath.

13. A method according to claim 1, wherein said bath contains liquid oxidic slags and molten pig iron at weight ratios of 1:3 to 1:6.

14. A method according to claim 2, wherein said bath contains liquid oxidic slags and molten pig iron at weight ratios of 1:3 to 1:6.

15. A method according to claim 3, where in said bath contains liquid oxidic slags and molten pig iron at weight ratios of 1:3 to 1:6.

16. A method according to claim 13, wherein said weight ratio is 1:4.

17. A method according to claim 1, wherein said dusts are pneumatically conveyed via bottom tuyeres.

18. A method according to claim 2, wherein said dusts are pneumatically conveyed via bottom tuyeres.

19. A method according to claim 3, wherein said dusts are pneumatically conveyed via bottom tuyeres.

20. A method according to claim 4, wherein said dusts are pneumatically conveyed via bottom tuyeres.
